(19) United States
(12) Patent Application Publication
(10) Pub. No.: US 2014/0071916 A1
(43) Pub. Date: Mar. 13, 2014

(54) APPARATUS AND METHOD FOR TRANSMITTING DISCOVERY SIGNAL

(71) Applicant: Electronics and Telecommunications Research Institute, Daejeon (KR)

(72) Inventors: Chanho YOON, Daejeon (KR); Hyung Jin KIM, Daejeon (KR); Seungkwon CHO, Gyeonggi-do (KR); Sung Kyung KIM, Daejeon (KR); Soojung JUNG, Daejeon (KR); Sung Cheol CHANG, Daejeon (KR)

(73) Assignee: Electronics and Telecommunications Research Institute, Daejeon (KR)

(21) Appl. No.: 14/022,797

(22) Filed: Sep. 10, 2013

(30) Foreign Application Priority Data
Sep. 11, 2012 (KR) 10-2012-0100266
Sep. 10, 2013 (KR) 10-2013-0108501

(51) Int. Cl. H04W 8/00

(52) U.S. Cl. CPC H04W 8/005
USPC 370/329

(57) ABSTRACT

A device transmits a discovery signal including identification information of the device in an empty discovery slot among a plurality of discovery slots of a discovery interval. The discovery signal includes two orthogonal frequency division multiplexing (OFDM) symbols. One of the two orthogonal frequency division multiplexing (OFDM) symbols includes at least one tone. The identification information of the device is displayed by a position of a subcarrier corresponding to the at least one tone.

### CROSS-REFERENCE TO RELATED APPLICATION

This application claims priority to and the benefit of Korean Patent Application Nos. 10-2012-0100266 and 10-2013-0108501 filed in the Korean Intellectual Property Office on Sep. 11, 2012 and Sep. 10, 2013, the entire contents of which are incorporated herein by reference.

### BACKGROUND OF THE INVENTION

(a) Field of the Invention

The present invention relates to an apparatus and a method for transmitting a discovery signal. More particularly, the present invention relates to an apparatus and a method for discovering a plurality of neighboring devices without an infrastructure.

(b) Description of the Related Art

In a conventional art, a technology of wireless devices recognizing one another is representatively applied to Bluetooth. In Bluetooth, manufacturers and serial numbers of devices are coded so that the devices recognize one another using access codes as preambles. Such a method has drawbacks in that the MAC-ID that a host has may not be entirely expressed and devices must have a complicated Bluetooth only hardware characteristic (a frequency hopping diffusion spectrum modulation technique).

In order to demodulate such types of codes, a master/slave relationship must be established, and in order for a receiver to find codes, processes of analyzing and searching the codes are required. Since settings are based on the master/slave relationship, a network is also limitedly supported, there are limitations on a method of expressing the devices, and complexity of transmitting/receiving processes is large. In addition, since the method is suitable for ultra-short distance communications, the method is not suitable for long distance data communications.

Recently, Qualcomm announced a FlashlinQ standard for neighboring communications. The FlashlinQ standard also suggests a communication method of identifying neighboring devices. FlashlinQ is designed to identify the neighboring devices by medium access control (MAC) addresses and service IDs that are hardware (H/W) addresses of the devices without generating codes using special manufacturers and serial numbers, unlike in the Bluetooth. A physical distance range of data communications is about 1 km, which is large. The FlashlinQ requires a global synchronization reference signal so that transmission signals among devices do not overlap. Therefore, the FlashlinQ requires an infrastructure such as a mobile communication base station or a global positioning system (GPS). On the other hand, the Bluetooth does not require an infrastructure.

As described above, in the Bluetooth, neighboring devices may be synchronized with each other without the infrastructure. However, a plurality of neighboring devices may not be discovered due to a distance range or a standard. On the other hand, in the FlashlinQ, a plurality of neighboring devices may be discovered. However, dependency on the infrastructure required for synchronization among the devices is large.

### SUMMARY OF THE INVENTION

An object of the present invention is to provide an apparatus and a method for transmitting a discovery signal to discover a plurality of neighboring devices without an infrastructure.

According to an exemplary embodiment of the present invention, a method for a device to transmit a discovery signal is provided. The discovery signal transmitting method includes generating a discovery signal including identification information of the device, and transmitting the discovery signal in an empty discovery slot among a plurality of discovery slots of a discovery interval. The discovery signal includes two orthogonal frequency division multiplexing (OFDM) symbols. One of the two orthogonal frequency division multiplexing (OFDM) symbols includes at least one tone. The identification information of the device is displayed by a position of a subcarrier corresponding to the at least one tone.

The other orthogonal frequency division multiplexing (OFDM) symbol of the two orthogonal frequency division multiplexing (OFDM) symbols may include a preamble.

The preamble may include a plurality of Golay sequences.

A length of the Golay sequences may be 128.

Transmitting the discovery signal in an empty discovery slot among a plurality of discovery slots of a discovery interval may include performing differential modulation on the at least one tone.

The discovery signal transmitting method may further include discovering a neighboring device from a discovery signal received in another discovery slot excluding the empty discovery slot among the plurality of discovery slots.

According to another exemplary embodiment of the present invention, a discovery signal transmitting apparatus for a device is provided. The discovery signal transmitting apparatus includes a signal generator and a signal transmitter. The signal generator generates a discovery signal including identification information of the device. The signal transmitter senses an empty discovery slot among a plurality of discovery slots of a discovery interval and transmits the discovery signal in the empty discovery slot. At this time, the discovery signal may include two orthogonal frequency division multiplexing (OFDM) symbols, one of the two orthogonal frequency division multiplexing (OFDM) symbols may include at least one Golay sequence used as a preamble, and the remaining one orthogonal frequency division multiplexing (OFDM) symbol may include the identification information of the device.

The signal generator may display the identification information of the device by positions of data subcarriers including a plurality of tones among a plurality of data subcarriers of the remaining one orthogonal frequency division multiplexing (OFDM) symbol.

Two tones may make a tone pair, and the signal transmitter may perform differential modulation on at least one tone pair.

Data subcarriers in which the plurality of tones are not included among the plurality of data subcarriers may be null subcarriers.

The discovery signal transmitting apparatus may further include a signal receiver. The signal receiver receives a discovery signal in at least one discovery slot among the plurality of discovery slots to discover a neighboring device.

### BRIEF DESCRIPTION OF THE DRAWINGS

FIG. 1 is a view illustrating an example of a frame according to an exemplary embodiment of the present invention.

FIG. 2 is a view illustrating an example of a discovery interval according to an exemplary embodiment of the present invention.

FIG. 3 is a view illustrating an example of a discovery signal according to an exemplary embodiment of the present invention.

FIG. 4 is a view illustrating an example of a method of displaying information using an orthogonal frequency division multiplexing (OFDM) data symbol according to an exemplary embodiment of the present invention.

FIGS. 5 and 6 are views illustrating another example of a method of displaying information using an OFDM data symbol according to an exemplary embodiment of the present invention.

FIG. 7 is a view illustrating still another example of a method of displaying information using an OFDM data symbol according to an exemplary embodiment of the present invention.

FIG. 8 is a view illustrating a discovery signal transmitting apparatus of a device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

Hereinafter, an apparatus and a method for transmitting a discovery signal according to an exemplary embodiment of the present invention will be described in detail with reference to the accompanying drawings.

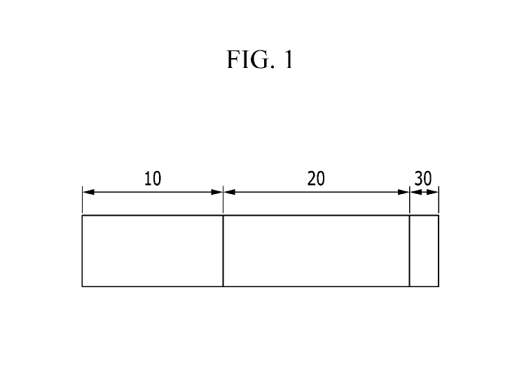

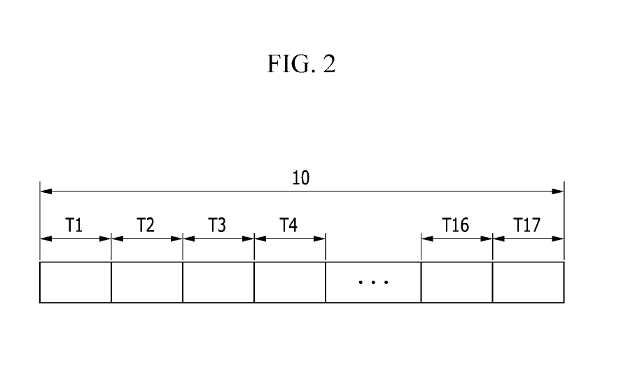

FIG. 1 is a view illustrating an example of a frame according to an exemplary embodiment of the present invention, and FIG. 2 is a view illustrating an example of a discovery interval according to an exemplary embodiment of the present invention.

Referring to FIG. 1, a partial frame of an entire frame includes a discovery interval 10. In addition, the frame may further include a data interval 20 and a synchronization interval 30.

In the discovery interval 10, each device finds neighboring devices.

Time synchronization among devices may be performed by a beacon signal transmitted and received in the synchronization interval 30.

Referring to FIG. 2, the discovery interval 10 includes a plurality of discovery slots, for example, 17 discovery slots T1 to T17. A device broadcasts a discovery signal including identification information of the device in an empty slot among the plurality of discovery slots, and listens to (receives) a discovery signal broadcasted by a neighboring device in another discovery slot to discover the neighboring device.

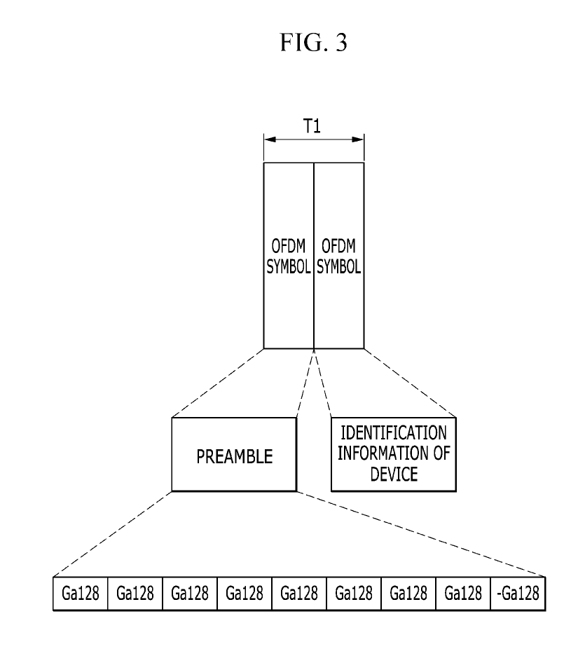

FIG. 3 is a view illustrating an example of a discovery signal according to an exemplary embodiment of the present invention. In FIG. 3, for convenience sake, only a discovery signal corresponding to one discovery slot T1 is illustrated.

Referring to FIG. 3, one discovery signal includes two orthogonal frequency division multiplexing (OFDM) symbols. One of the two orthogonal frequency division multiplexing (OFDM) symbols includes a preamble. The preamble includes a plurality of Golay sequences, for example, a plurality of Golay 128 sequences Ga128. A receiver detects a discovery interval using the preamble. At this time, in order to increase probability of the receiver detecting the discovery interval, the preamble may further include Golay −128 sequences −Ga128.

A length of the Golay 128 sequences is 128, and the Golay sequences include “−1, −1, 1, 1, 1, 1, 1, 1, 1, −1, 1, −1, −1, 1, 1, −1, −1, −1, 1, 1, −1, −1, −1, −1, 1, −1, 1, −1, 1, −1, −1, 1, 1, 1, −1, −1, −1, −1, −1, −1, −1, 1, −1, 1, 1, −1, −1, 1, −1, −1, 1, 1, −1, −1, −1, −1, 1, −1, 1, −1, 1, −1, −1, 1, 1, 1, −1, −1, −1, −1, −1, −1, −1, 1, −1, 1, 1, −1, −1, 1, 1, 1, −1, −1, 1, 1, 1, 1, −1, 1, −1, 1, −1, 1, 1, −1, 1, 1, −1, −1, −1, −1, −1, −1, −1, 1, −1, 1, 1, −1, −1, 1, −1, −1, 1, 1, −1, −1, −1, −1, 1, −1, 1, −1, 1, −1, −1, 1”. The Golay sequences are used for estimating a channel. When the Golay sequences are used, a cross-correlator of the receiver may be simply realized. For example, it is possible to design a correlator of a structure in which addition operations are not performed 127 times but are performed seven times in order to obtain correlation of the Golay sequences having the length of 128.

The remaining one orthogonal frequency division multiplexing (OFDM) symbol of the two orthogonal frequency division multiplexing (OFDM) symbols includes data. The data may include identification information of a device. For convenience sake, the orthogonal frequency division multiplexing (OFDM) symbol including the data is referred to as an orthogonal frequency division multiplexing (OFDM) data symbol.

The OFDM data symbol displays information by a position of a tone. The information may be the identification information of the device. The OFDM data symbol includes a plurality of valid data subcarriers. The number of bits and information on the bits, that is, the identification information of the device, may be displayed by a position of a data subcarrier including the tone among the plurality of valid data subcarriers. The remaining data subcarriers excluding the data subcarrier including the tone among the plurality of valid data subcarriers are null subcarriers, and the tone has power by which the tone is distinguished from a null signal.

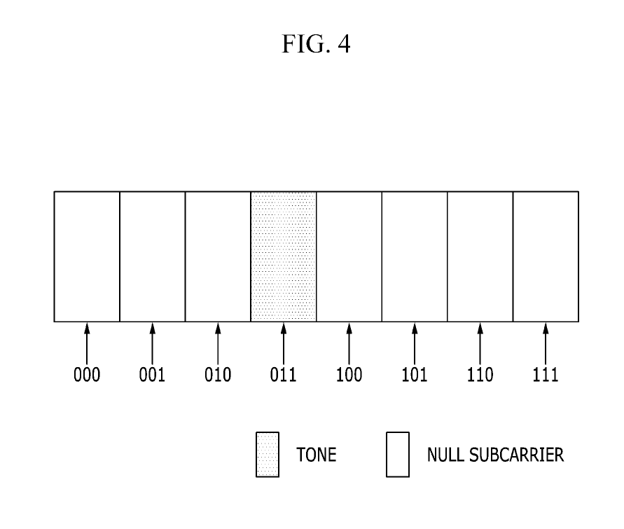

FIG. 4 is a view illustrating a method of displaying information using an OFDM data symbol according to an exemplary embodiment of the present invention.

For example, in FIG. 4, it is assumed that the OFDM data symbol includes eight data subcarriers in a frequency axis. The eight data subcarriers S1 to S8 represent 000, 001, 010, 011, 100, 101, 110, and 111 in accordance with positions thereof. When a tone is included in the data subcarrier S4, a receiver may obtain information of three bits, that is, 011, from the position of the data subcarrier S4 including the tone.

As described above, information may be displayed by a position of one tone. However, information may be displayed by positions of at least two tones.

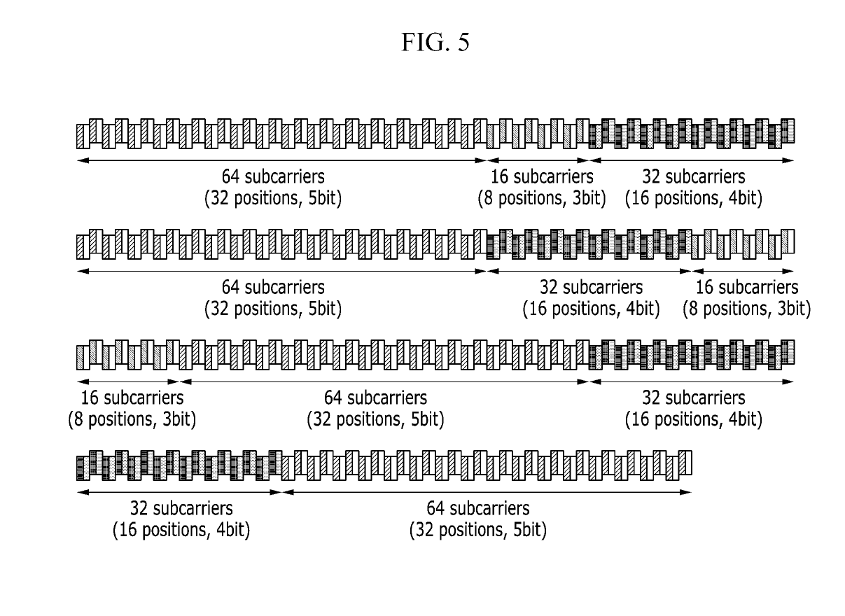

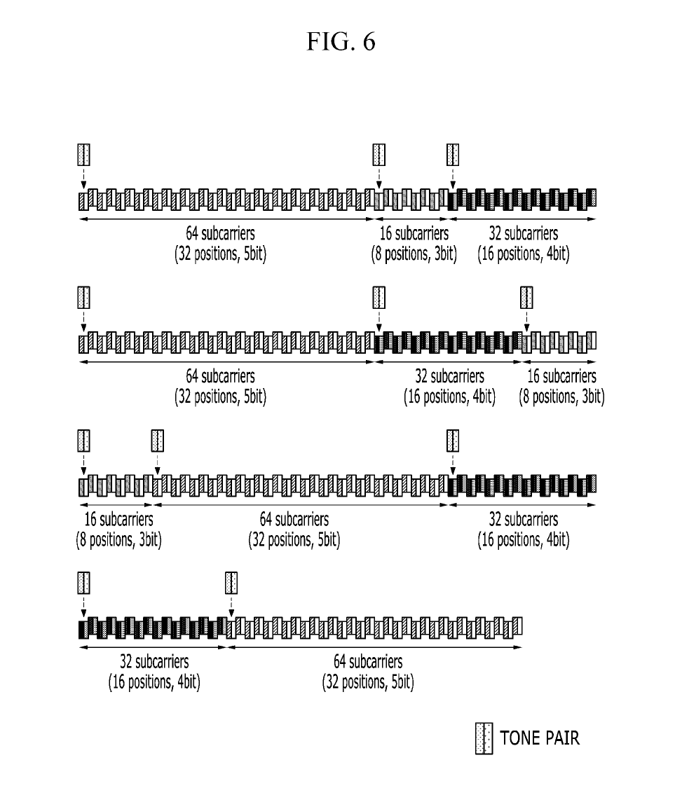

FIGS. 5 and 6 are views illustrating another example of a method of displaying information using an OFDM data symbol according to an exemplary embodiment of the present invention.

As illustrated in FIG. 5, an orthogonal frequency division multiplexing (OFDM) data symbol may include 432 valid data subcarriers. Two data subcarriers make a subcarrier pair, and two tones make a tone pair so that the tone pair may be included in the subcarrier pair. Information may be displayed by positions of data subcarriers including the tone pair. In the structure of FIG. 5, information of 43 bits may be displayed by one OFDM data symbol.

To be specific, the 432 valid data subcarriers are divided into a plurality of domains, and the information is displayed by positions of data subcarriers including a plurality of tone pairs in the plurality of domains. The respective domains may represent positions of bits.

For example, it is assumed that the 432 valid data subcarriers are divided into 11 domains, that is, 64 data subcarriers, 32 data subcarriers, 16 data subcarriers, 64 data subcarriers, 16 data subcarriers, 32 data subcarriers, 16 data subcarriers, 64 data subcarriers, 32 data subcarriers, 32 data subcarriers, and 64 data subcarriers.

The 64 data subcarriers may represent 32 positions so that the 64 data subcarriers may display information of five bits. The 32 data subcarriers may represent 16 positions so that the 32 data subcarriers may display information of four bits. The 16 data subcarriers may represent eight positions so that the 16 data subcarriers may display information of three bits.

Therefore, the 64 data subcarriers, the 16 data subcarriers, the 8 data subcarriers, the 64 data subcarriers, the eight data subcarriers, the 16 data subcarriers, the eight data subcarriers, the 64 data subcarriers, the 16 data subcarriers, the 32 data subcarriers, and the 64 data subcarriers corresponding to the 11 domains may represent five bits, three bits, four bits, five bits, four bits, three bits, three bits, five bits, four bits, four bits, and five bits. As a result, information of a total of 43 bits may be displayed.

For example, “0000000000000000000000000000000000000000000” may be displayed by inserting 11 tone pairs into first subcarrier pairs of the 11 domains, respectively, as illustrated in FIG. 6.

When the 432 valid data subcarriers are divided into the 11 domains, the 432 valid data subcarriers may be divided into the 64 data subcarriers, the 32 data subcarriers, the 16 data subcarriers, the 64 data subcarriers, the 32 data subcarriers, the 16 data subcarriers, the 64 data subcarriers, the 32 data subcarriers, the 16 data subcarriers, the 64 data subcarriers, and the 32 data subcarriers with a uniform pattern or periodicity. However, as described above, when the valid data subcarriers are divided into the domains with the uniform pattern or periodicity, a peak-to-average power ratio (PAPR) is increased when a signal of a frequency domain is converted into a signal of a time domain. Therefore, the 432 valid data subcarriers may be divided into, for example, the 64 data subcarriers, the 32 data subcarriers, the 16 data subcarriers, the 64 data subcarriers, the 16 data subcarriers, the 32 data subcarriers, the 16 data subcarriers, the 64 data subcarriers, the 32 data subcarriers, the 32 data subcarriers, and the 64 data subcarriers without the uniform pattern or periodicity so that the PAPR may be reduced.

As described above, since the identification information of the device of the total 43 bits may be displayed by one OFDM data symbol using the 11 tone pairs, the device may entirely express a medium access control (MAC) address, and a plurality of neighboring devices may be discovered from a plurality of discovery slots without the infrastructure in the frame structure of FIG. 1.

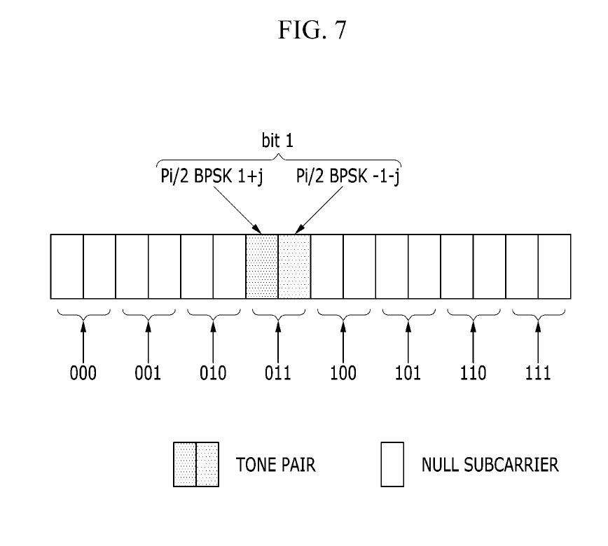

FIG. 7 is a view illustrating still another example of a method of displaying information using an OFDM data symbol according to an exemplary embodiment of the present invention.

Referring to FIG. 7, it is assumed that 16 data subcarriers S1 to S16 exist in a frequency axis and two data subcarriers make data subcarrier pairs P1 to P8. The eight data subcarrier pairs P1 to P8 represent 000, 001, 010, 011, 100, 101, 110, and 111 in accordance with positions thereof. When tones are included in the data subcarrier pair P4, a receiver may obtain information of three bits, that is, 011, from the position of the data subcarrier pair P4 including the tones. A device may perform differential modulation on the two tones of the data subcarrier pair P4. When the differential modulation is performed, additional one bit information of “0” or “1” may be displayed. That is, since the bit 0 or the bit 1 may be represented by a phase difference between the two tones of the data subcarrier pair P4, information of one bit may be further represented by performing differential modulation on the two tones. For example, as illustrated in FIG. 6, when quadrature phase shift keying (QPSK) signals of the two tones are 1+j and −1−j, respectively, a phase difference of 180 degrees is generated so that the bit 1 may be represented.

For example, in FIG. 5, when the differential modulation is performed on the 11 tone pairs, a device may further represent 11 bits and may resultantly display information of a total 54 of bits (43 bits+11 bits).

In addition, when the differential modulation is performed, a receiver may improve receiving performance and may demodulate the two tones of the data subcarrier pair P4 with low complexity without a channel estimating process.

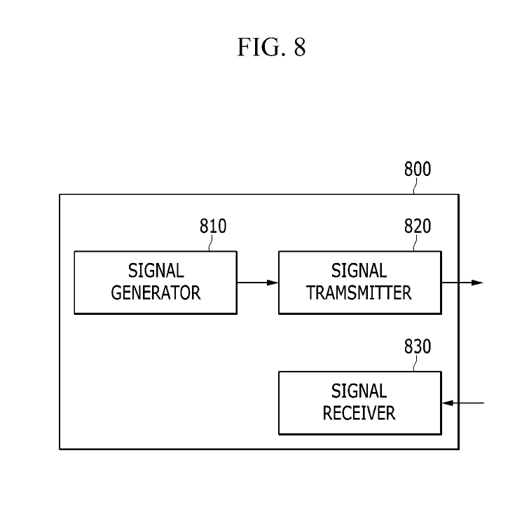

FIG. 8 is a view illustrating a discovery signal transmitting apparatus of a device according to an exemplary embodiment of the present invention.

Referring to FIG. 8, a discovery signal transmitting apparatus 800 of a device includes a signal generator 810, a signal transmitter 820, and a signal receiver 830.

The signal generator 810 generates a discovery signal including identification information of the device. The discovery signal includes two OFDM symbols as described above. One of the two OFDM symbols includes Golay sequences and the remaining OFDM symbol includes the identification information of the device. The identification information of the device may be displayed by a position of a data subcarrier including at least one tone in the OFDM symbol.

The signal transmitter 820 senses an empty discovery slot among a plurality of discovery slots and broadcasts a discovery signal in the empty discovery slot. At this time, the signal transmitter 820 may perform differential modulation on the data subcarrier including the at least one tone.

The signal receiver 830 listens to (receives) a discovery signal broadcasted by a neighboring device in at least one discovery slot among the plurality of discovery slots to discover the neighboring device.

According to the exemplary embodiment of the present invention, a plurality of neighboring devices may be efficiently discovered without an infrastructure.

The exemplary embodiment of the present invention is not realized only by the above-described apparatus and/or method, but may also be realized by a program for realizing a function corresponding to a configuration of the exemplary embodiment of the present invention and a recording medium in which the program is recorded. Such realization may be easily performed by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a device to transmit a discovery signal, the method comprising:
generating a discovery signal including identification information of the device; and
transmitting the discovery signal in an empty discovery slot among a plurality of discovery slots of a discovery interval,
wherein the discovery signal comprises two orthogonal frequency division multiplexing (OFDM) symbols,
wherein one of the two orthogonal frequency division multiplexing (OFDM) symbols comprises at least one tone, and
wherein the identification information of the device is displayed by a position of a subcarrier corresponding to the at least one tone.

2. The method of claim 1, wherein the other orthogonal frequency division multiplexing (OFDM) symbol of the two orthogonal frequency division multiplexing (OFDM) symbols comprises a preamble.

3. The method of claim 2, wherein the preamble comprises a plurality of Golay sequences.

4. The method of claim 3, wherein a length of the Golay sequences is 128.

5. The method of claim 3, wherein the Golay sequences comprise −1, −1, 1, 1, 1, 1, 1, 1, 1, −1, 1, −1, −1, 1, 1, −1, −1, −1, 1, 1, −1, −1, −1, −1, 1, −1, 1, −1, 1, −1, −1, 1, 1, 1, −1, −1, −1, −1, −1, −1, −1, 1, −1, 1, 1, −1, −1, 1, −1, −1, 1, 1, −1, −1, −1, −1, 1, −1, 1, −1, 1, −1, −1, 1, 1, 1, −1, −1, −1, −1, −1, −1, −1, 1, −1, 1, 1, −1, −1, 1, 1, 1, −1, −1, 1, 1, 1, 1, −1, 1, −1, 1, −1, 1, 1, −1, 1, 1, −1, −1, −1, −1, −1, −1, −1, 1, −1, 1, 1, −1, −1, 1, −1, −1, 1, 1, −1, −1, −1, −1, 1, −1, 1, −1, 1, −1, −1, 1.

6. The method of claim 1, wherein transmitting the discovery signal in an empty discovery slot among a plurality of discovery slots of a discovery interval comprises performing differential modulation on the at least one tone.

7. The method of claim 1, further comprising discovering a neighboring device from a discovery signal received in another discovery slot excluding the empty discovery slot among the plurality of discovery slots.

8. A discovery signal transmitting apparatus for a device, comprising:
a signal generator for generating a discovery signal including identification information of the device; and
a signal transmitter for sensing an empty discovery slot among a plurality of discovery slots of a discovery interval and transmitting the discovery signal in the empty discovery slot,
wherein the discovery signal comprises two orthogonal frequency division multiplexing (OFDM) symbols, and
wherein one of the two orthogonal frequency division multiplexing (OFDM) symbols comprises at least one Golay sequence used as a preamble and the remaining one orthogonal frequency division multiplexing (OFDM) symbol comprises the identification information of the device.

9. The discovery signal transmitting apparatus of claim 8, wherein the signal generator displays the identification information of the device by positions of data subcarriers including a plurality of tones among a plurality of data subcarriers of the remaining one orthogonal frequency division multiplexing (OFDM) symbol.

10. The discovery signal transmitting apparatus of claim 9, wherein two tones make a tone pair, and
wherein the signal transmitter performs differential modulation on at least one tone pair.

11. The discovery signal transmitting apparatus of claim 9, wherein data subcarriers in which the plurality of tones are not included among the plurality of data subcarriers are null subcarriers.

12. The discovery signal transmitting apparatus of claim 8, wherein a length of the Golay sequence is 128.

13. The discovery signal transmitting apparatus of claim 8, wherein the Golay sequence comprises −1, −1, 1, 1, 1, 1, 1, 1, 1, −1, 1, −1, −1, 1, 1, −1, −1, −1, 1, 1, −1, −1, −1, −1, 1, −1, 1, −1, 1, −1, −1, 1, 1, 1, −1, −1, −1, −1, −1, −1, −1, 1, −1, 1, 1, −1, −1, 1, −1, −1, 1, 1, −1, −1, −1, −1, 1, −1, 1, −1, 1, −1, −1, 1, 1, 1, −1, −1, −1, −1, −1, −1, −1, 1, −1, 1, 1, −1, −1, 1, 1, 1, −1, −1, 1, 1, 1, 1, −1, 1, −1, 1, −1, 1, 1, −1, 1, 1, −1, −1, −1, −1, −1, −1, −1, 1, −1, 1, 1, −1, −1, 1, −1, −1, 1, 1, −1, −1, −1, −1, 1, −1, 1, −1, 1, −1, −1, 1.

14. The discovery signal transmitting apparatus of claim 8, further comprising a signal receiver for receiving a discovery signal in at least one discovery slot among the plurality of discovery slots to discover a neighboring device.
